(19) United States
(12) Patent Application Publication
(10) Pub. No.: US 2025/0258365 A1
(43) Pub. Date: Aug. 14, 2025

(54) DISPLAY OPTICAL SYSTEM AND IMAGE DISPLAY APPARATUS

(71) Applicant: CANON KABUSHIKI KAISHA, Tokyo (JP)

(72) Inventors: MASAKAZU TOHARA, Tokyo (JP); TAKAYUKI SUGIYAMA, Tochigi (JP)

(21) Appl. No.: 19/049,871

(22) Filed: Feb. 10, 2025

(30) Foreign Application Priority Data
Feb. 14, 2024 (JP) 2024-019879

(51) Int. Cl. G02B 17/08; G02B 5/30; G02B 13/18

(52) U.S. Cl. CPC G02B 17/0856; G02B 5/3025; G02B 13/18

(57) ABSTRACT

A display optical system is configured to guide light from a display element to an observation side. The display optical system includes a half-transmissive reflective surface, a polarization separation surface, and a plurality of polarization elements. At least one of surfaces having refractive power in the display optical system is aspheric. At least one of the half-transmissive reflective surface or the polarization separation surface includes a film element. The film element is adhered to one of the plurality of polarization elements or a lens via a first adhesive layer on a reflection side of the film element. A predetermined inequality is satisfied.

### BACKGROUND

### Technical Field

The present disclosure relates to a display optical system suitable for an image display apparatus such as a head mount display (HMD) that displays an enlarged original image displayed on a display element.

### Description of Related Art

As an example of such a display optical system, Japanese Patent Applications Laid-Open Nos. 2000-275566 and 2019-148626 disclose an optical system that folds an optical path by utilizing polarization and includes a polarization selective element (polarization separation element) and a half-mirror.

### SUMMARY

A display optical system according to one aspect of the disclosure is configured to guide light from a display element to an observation side. The display optical system includes a half-transmissive reflective surface, a polarization separation surface, and a plurality of polarization elements. At least one of surfaces having refractive power in the display optical system is aspheric. At least one of the half-transmissive reflective surface or the polarization separation surface includes a film element. The film element is adhered to one of the plurality of polarization elements or a lens via a first adhesive layer on a reflection side of the film element. The following inequality is satisfied:

$$5 μm \leq d 1 < 20 μm$$

where d1 is a thickness of the first adhesive layer. An image pickup apparatus having the above display optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates an image observation apparatus that includes a display optical system according to a first embodiment.

FIG. 2 is a detailed diagram illustrating the configuration of the display optical system according to the first embodiment.

FIG. 3 is an external view of an image display apparatus according to FIG. 1.

FIG. 4 is a partially enlarged view of the display optical system according to the first embodiment.

FIG. 5 illustrates local contrast decrease of a displayed image.

FIG. 6 illustrates an image observation apparatus that includes a display optical system according to a second embodiment.

FIG. 7 is a detailed diagram illustrating the configuration of the display optical system according to the second embodiment.

FIG. 8 is a partially enlarged view of the display optical system according to the second embodiment.

FIG. 9 is another partially enlarged view of the display optical system according to the second embodiment.

FIG. 10 is a detailed diagram illustrating the configuration of the display optical system according to a third embodiment.

FIG. 11 is a partially enlarged view of the display optical system according to the third embodiment.

FIG. 12 is another partially enlarged view of the display optical system according to the third embodiment.

FIGS. 13A and 13B illustrate an example in which local contrast decrease is improved in this embodiment.

### DETAILED DESCRIPTION

Referring now to the accompanying drawings, a description will be given of embodiments according to the disclosure.

### First Embodiment

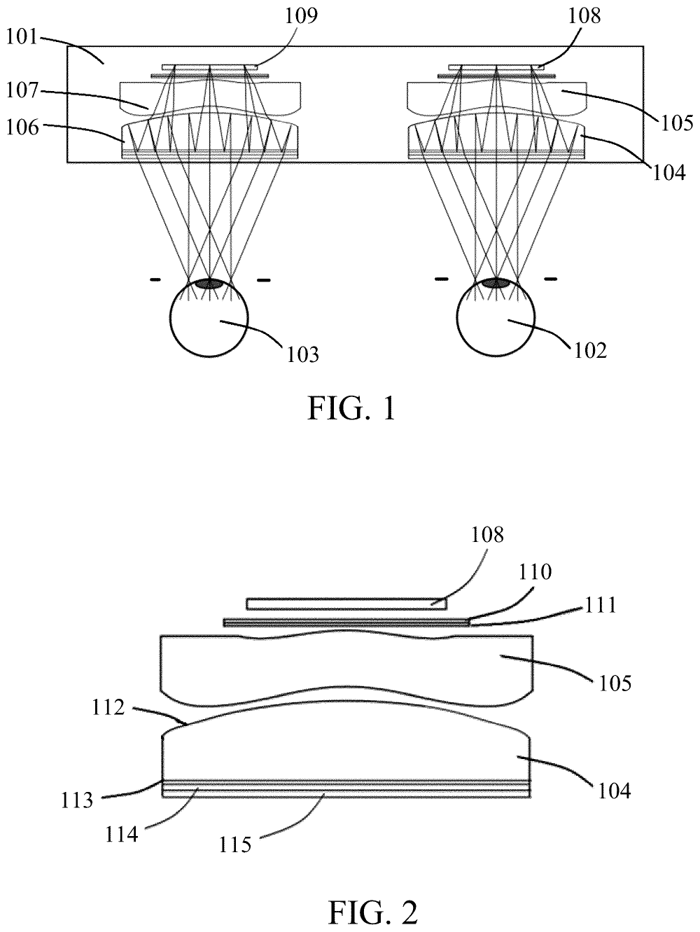

FIG. 1 illustrates the configuration of an HMD 101 as an image display apparatus using a display optical system according to a first embodiment, viewed from above. Reference numeral 102 denotes a right eye of an observer, and reference numeral 103 denotes a left eye of the observer. Lenses 104 and 105 form part of a right-eye display optical system, and lenses 106 and 107 form part of a left-eye display optical system. Reference numeral 108 denotes a right-eye display element, and reference numeral 109 denotes a left-eye display element, each of which uses an organic electro-luminescence (EL) element in this embodiment.

The right-eye display optical system enlarges light (virtual image) from an original image displayed on the right-eye display element 108 and guides it to the right eye 102 disposed on the observation side, and the left-eye display optical system enlarges light from an original image displayed on the left-eye display element 109 and guides it to the left eye 103 disposed on the observation side.

Each of the right-eye display optical system and the left-eye display optical system has a focal length f1 of 12 mm, a horizontal display angle of view of 55°, a vertical display angle of view of 40°, and a diagonal display angle of view 2×θ1 of 65°. In order to enhance the immersion of the observer who observes an image, the diagonal display angle of view may be 60° or more. A distance (eye relief) E1 between the HMD 101 and the observer's eyeball is 25 mm.

The display optical system according to this embodiment is an optical system that folds the optical path by using polarization, and its specific configuration will be described using the right-eye display optical system illustrated in FIG. 2. The right-eye display optical system includes, in order from the display element side, a first polarizing plate 110 and a first phase plate 111 between the right-eye display element 108 and the lens 105. Each of the first polarizing plate 110 and the first phase plate 111 has a planar shape and they are laminated.

A half-mirror 112 constituting a half-transmissive reflective surface is formed by vapor deposition on a display-element-side (lens-105-side) surface of the lens 104. The right-eye display optical system further includes, in order from the display element side (lens 104 side) between the lens 104 and the right eye 102, a second phase plate 113, a polarization separation element (polarization beam splitter: PBS) 114 constituting a polarization separation surface, and a second polarizing plate 115. The polarization separation surface is an optically functional surface whose transmittance and reflectance change according to the polarization direction of the incident light. Each of the second phase plate 113, the PBS 114, and the second polarizing plate 115 has a planar shape and they are laminated. Each of the first phase plate 111 and the second phase plate 113 includes a quarter waveplate.

A polarization direction of polarized light that transmits through the first polarizing plate 110 and a slow axis of the first phase plate 111 are tilted by 45° to each other. The polarization direction of the polarized light that transmits through the first polarizing plate 110 and a slow axis of the second phase plate 113 are tilted by −45° to each other. The polarization direction of the polarized light that transmits through the first polarizing plate 110 and a polarization direction of polarized light that transmits through the PBS 114 are orthogonal to each other. The polarization direction of polarized light that transmits through the second polarizing plate 115 and the polarization direction of the polarized light transmitted by the PBS 114 coincide with each other.

In the above configuration, unpolarized light emitted from the right-eye display element 108 transmits through the first polarizing plate 110 and becomes linearly polarized light, and this linearly polarized light transmits through the first phase plate 111 and becomes circularly polarized light. The circularly polarized light that has transmitted through the half-mirror 112 transmits through the second phase plate 113 and becomes linearly polarized light, and since the polarization direction of this linearly polarized light is orthogonal to the polarization direction of the polarized light that transmits through the PBS 114, it is reflected by the PBS 114. The reflected linearly polarized light then transmits through the second phase plate 113 and becomes circularly polarized light.

The circularly polarized light that has been reflected by the half-mirror 112 transmits through the second phase plate 113 and becomes linearly polarized light. This linearly polarized light transmits through the PBS 114 because its polarization direction coincides with the polarization direction of the polarized light that transmits through the PBS 114, and then transmits through the second polarizing plate 115 and is guided to the right eye 102. The second polarizing plate 115 can reduce ghost light generated by external light, and increase the contrast of the displayed image. The above configuration is similarly applied to the left-eye display optical system.

Folding the optical path utilizing polarization as in this embodiment can reduce the thickness of the display optical system and the focal length, and achieve image observation at a wide angle of view.

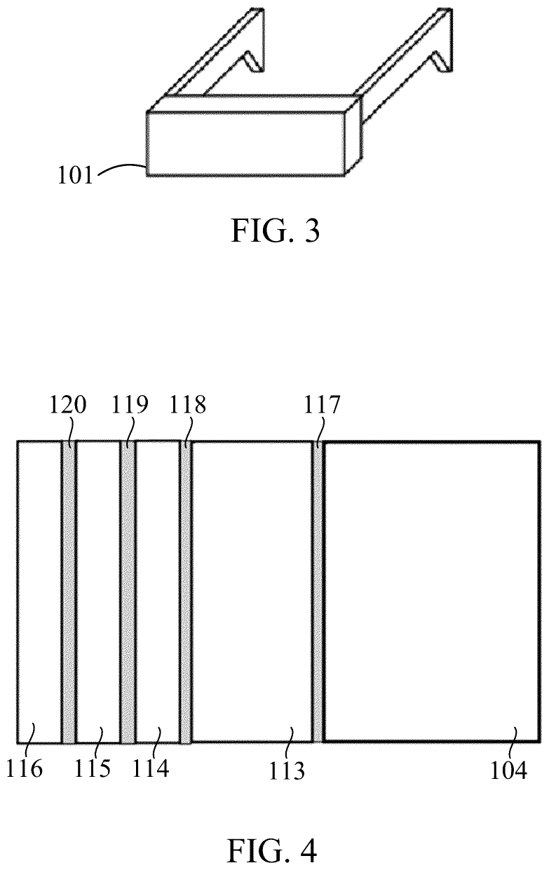

FIG. 3 illustrates the external appearance of the HMD 101. Since the HM 101 is worn on the observer's head, it may have a reduced weight. Thus, the lenses constituting the display optical system may be made of resin, which has a smaller specific gravity than glass, and in this embodiment, the lenses 104 and 106 are made of resin. The lenses 104 and 106 as aspherical lenses with a plano-convex shape can improve an aberration correcting effect. The lenses 105 and 107 are made of resin and have aspheric surfaces on both sides.

The exit pupil position of the display optical system in this embodiment is 35 mm, which is the sum of an eye relief of 25 mm and the eyeball's rotation radius of 10 mm, and the exit pupil diameter is 6 mm. Thereby, light in directions in which the eyeball rotates to observe up, down, left, or right can enter the eyeball. The eye relief may be 15 mm or more so that observers wearing glasses can also wear HMD 101. Since a longer eye relief results in a larger lens outer shape and therefore a larger HMD 101, the eye relief may be 25 mm or less.

FIG. 4 illustrates the second phase plate 113, the PBS 114, and the second polarizing plate 115, which are laminated on the observation-side surface of lens 104 and adhered together by an adhesive. An adhesive layer 117 is provided between the observation-side surface of the lens 104 and the second phase plate 113, an adhesive layer (first adhesive layer) 118 is provided between the second phase plate 113 and the PBS 114, and an adhesive layer 119 is provided between the PBS 114 and the second polarizing plate 115. Laminating the second phase plate 113, the PBS 114, and the second polarizing plate 115 in this manner can reduce the thickness of the display optical system. An antireflection (AR) film 116 for preventing reflection of external light is adhered to an observation-side surface of the second polarizing plate 115 via an adhesive layer 120.

In this embodiment, the PBS 114 includes a thin film-like element (film element), and if the adhesive layer 118 between the PBS 114 and the second phase plate 113 has thickness variation (unevenness or irregularities) in the in-plane direction, unevenness corresponding to that unevenness will appear on the PBS 114. In particular, if the thickness of the adhesive layer 118 between the PBS 114 and the second phase plate 113 disposed on the reflection side of the PBS 114 changes periodically, the PBS 114 with corresponding unevenness generates local optical power for the light reflected by the PBS 114. In a case where local optical power is generated by the PBS 114, a local focus shift occurs in the displayed image, and the displayed image is observed as a blurred image with decreased contrast.

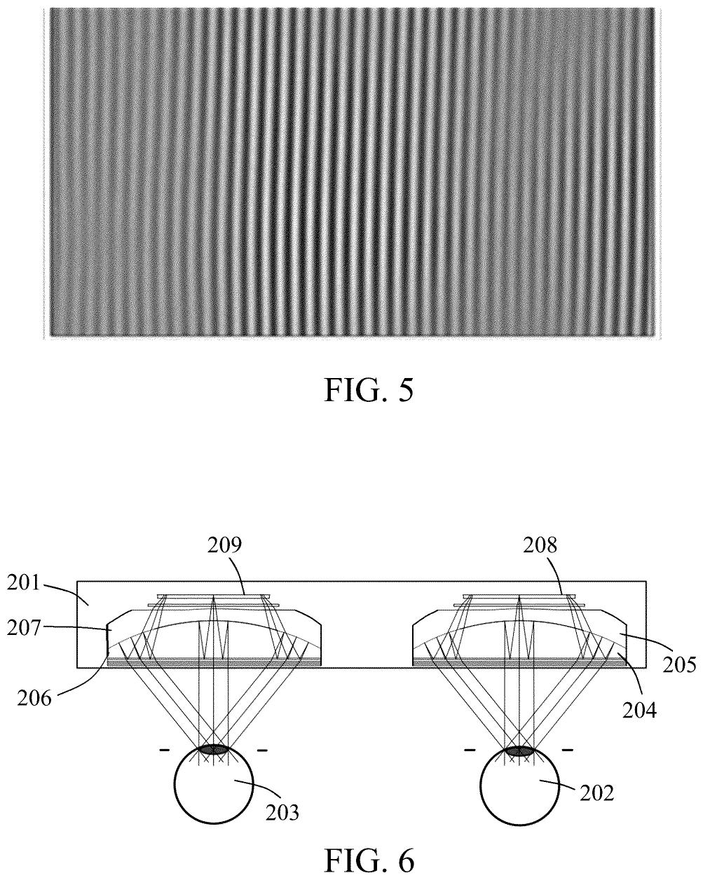

FIG. 5 illustrates how the unevenness of the PBS 114 locally reduces the contrast in a displayed image including vertical lines. The contrast of the vertical lines is high near the center of FIG. 5, but low in the left and right portions.

Accordingly, this embodiment reduces the thickness of the adhesive layer 118 between the PBS 114 and the second phase plate 113, and suppresses the unevenness (particularly the periodic unevenness) of the adhesive layer 118 and thereby the generation of local optical power in the PBS 114. More specifically, the thickness of the adhesive layer 118 is set to 15 μm, and the thickness variation is suppressed to 6 μm (tolerance±3 μm). Basically, the thickness d1 of the adhesive layer 118 between the PBS 114 having a reflecting action and the second phase plate 113 may be 5 μm or more and 20 μm or less so as to satisfy an inequality of 5 μm≤d1≤20 μm. In a case where the thickness of the adhesive layer 118 is 20 μm or more, the thickness variation increases, unevenness is likely to appear on the PBS 114, and the optical power generated by that unevenness increases. On the other hand, in a case where the thickness of the adhesive layer 118 becomes less than 5 μm, it becomes difficult to adhere the PBS 114 and the second phase plate 113, and wrinkles and air bubbles are likely to occur during adhesion. The thickness d1 of the adhesive layer 118 may be 19 μm or less, 18 μm or less, or 16 μm or less. This is similarly applied to the thickness d1 of the adhesive layer in other embodiments described later.

A thickness variation amount Δd1 of the adhesive layer 118 may be less than 10 μm so as to satisfy an inequality of 0<Δd1<10 μm. In a case where the thickness variation amount of the adhesive layer 118 is 10 μm or more, unevenness is likely to appear on the PBS 114, and the optical power generated by the unevenness increases.

The observer is sensitive to a local contrast decrease near the center of the displayed image (for example, a range of 30° horizontally and 20° vertically, which is the effective visual field of the human eye). Therefore, the thickness variation of the adhesive layer 118 within the width of the light beam incident on the observer's eye near the optical axis of the display optical system, which corresponds to the vicinity of the center of the displayed image, may be as small as possible. More specifically, in a case where the light beam emitted from a pixel on the optical axis of the display optical system among the display elements is reflected by the PBS 114, the ratio of the variation amount Δd1 to the light beam width Φ1 may be less than 0.002 so as to satisfy the following inequality:

$$0 < Δ d 1 / Φ 1 < 0.002$$

In this embodiment, the thickness variation amount Δd1 of the adhesive layer 118 near the center is 4 μm, and since the diameter of the pupil of the observer's eye (=Φ1) is about 4 mm, Δd1/Φ1 is 0.001.

In a case where the unevenness of the adhesive layer 118 is periodic, the period of the unevenness may be twice or more as long as the light beam width Φ1. In a case where the period of the unevenness is less than twice as long as the light beam width Φ1, the optical power of the PBS 114 caused by the unevenness of the adhesive layer 118 increases.

The thickness of the PBS 114, 60 μm, is four times as long as the thickness of the adhesive layer 118. As the thickness of the PBS 114 becomes large relative to the thickness of the adhesive layer 118, the unevenness of the adhesive layer 118 will be less likely to appear on the PBS 114, and local optical power is less likely to occur. Thus, the thickness of the PBS 114 may be three times or more as long as the thickness of the adhesive layer 118. On the other hand, in a case where the thickness of the PBS 114 increases, it becomes difficult to reduce the thickness of the display optical system, so the thickness of the PBS 114 may be 15 times or less as long as the thickness of the adhesive layer 118.

Thus, reducing the thickness of the adhesive layer 118 between the PBS 114 and the polarization element (second phase plate 113) adjacent to and disposed on the reflection side of the PBS 114 and the thickness variation can reduce the unevenness generated on the PBS 114. Since the PBS 114 has a reflecting action, the influence of local unevenness on the optical power is greater than that of a surface with a transmitting action, and local contrast decrease is likely to occur in the displayed image. Therefore, reducing the unevenness of the adhesive layer 118 between the PBS 114 and the second phase plate 113 adjacent to and disposed on the reflection side of the PBS 114 can reduce the unevenness of the PBS 114 and suppress the local contrast decrease in the displayed image.

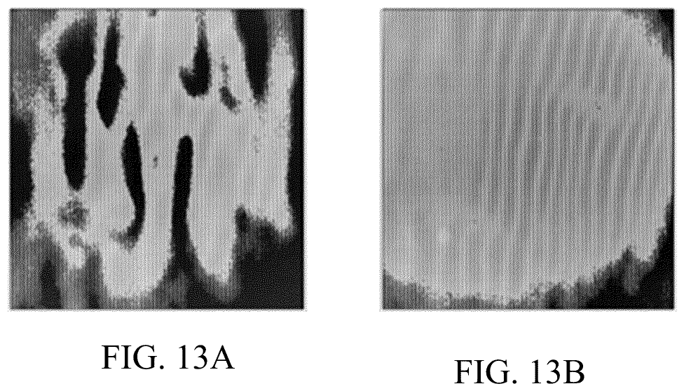

FIG. 13A illustrates an example of a display image different from that of FIG. 5, in which a local contrast decrease occurs due to the unevenness of the adhesive layer 18. Areas where the contrast is decreased are illustrated in black. In this display image, a plurality of multiple areas where the contrast is decreased, which gives an unnatural feeling. On the other hand, FIG. 13B illustrates a display image in which the unevenness of the adhesive layer 18 is reduced as in this embodiment, and the local contrast decrease is suppressed.

While the thickness of the adhesive layer 118 between the PBS 114 and the second phase plate 113 has been described, but the thickness of the adhesive layer 119 between the PBS 114 and the second polarizing plate 115 may also be reduced to suppress the thickness variation. In this embodiment, the thickness of the adhesive layer 119 is 20 μm, and the thickness variation is 8 μm (±4 μm). The thickness variation of the adhesive layer 119 near the center is 5 μm, and a ratio of this thickness variation to the light beam width near the center is 0.00125.

In this embodiment, the AR film 116 is adhered to the observation-side surface of the second polarizing plate 115 via the adhesive layer 120. Similarly to the PBS 114, in a case where there is unevenness at the interface between the AR film 116 and air, local optical power is generated and the contrast decreases. Accordingly, this embodiment reduces the thickness of the adhesive layer 120 between the AR film 116 and the second polarizing plate 115 to suppress the unevenness of the adhesive layer 120.

More specifically, the thickness d2 of the adhesive layer 120 is 14 μm, and the thickness variation Δd2 is 10 μm (±5 μm). Basically, the thickness d2 of the adhesive layer 120 between the AR film 116, which has a transmitting effect, and the second polarizing plate 115 may be 5 μm or more and less than 20 μm so as to satisfy an inequality 5 μm≤d2<20 μm. In a case where the thickness of the adhesive layer 120 becomes 20 μm or more, the unevenness of the adhesive layer 120 increases, and unevenness corresponding to that unevenness will appear in the AR film 116. In a case where the thickness of the adhesive layer 120 is less than 5 μm, the adhesive layer 120 reduces, it becomes difficult to attach the AR film 116 to the second polarizing plate 115, and wrinkles and air bubbles are likely to occur during attachment.

The thickness d2 of the adhesive layer 120 may be 19 μm or less, 18 μm or less, or 16 μm or less. This is similarly applied to the thickness d2 of the adhesive layer in other examples described later.

The thickness variation Δd2 of the adhesive layer 120 may be less than 20 μm so as to satisfy the inequality 0<Δd2<20 μm. In a case where the thickness variation is 20 μm or more, the unevenness of the adhesive layer 120 generates optical power in the AR film 116.

Near the center, the thickness variation Δd2 of the adhesive layer 120 is 8 μm. Where Φ2 is a light beam width of a light beam emitted from the pixel on the optical axis of the display element in a case where the light beam transmits through the adhesive layer 120, Δd2/Φ2 is 0.002. Δd2/Φ2 may be less than 0.005 so as to satisfy an inequality of 0<Δd2/Φ2<0.005.

The focal length of the display optical system according to this embodiment is 12 mm, and in a case where the focal length of the display optical system is short and the optical power is large, optical power differences from the PBS 114 and the AR film 116 increase, and the influence is less likely. Thus, the focal length of the display optical system may be 20 mm or less, or 16 mm or less. In a case where the focal length is too short, the optical performance decreases and high-quality image observation becomes impossible, so the focal length f may be 10 mm or more, or 12 mm or more. That is, the following inequality may be satisfied:

10 mm≤f≤20 mm or 12 mm≤f≤16 mm

In this embodiment, the surface of the lens 104 on which the half-mirror 112 is vapor-deposited has a convex shape on the display element side. Vapor-depositing the half-mirror on this convex surface can achieve a wide angle of view and reduces the thickness of the display optical system. Making the convex surface on which the half-mirror 112 is vapor-deposited aspheric can improve the aberration correcting effect.

In this embodiment, the observation-side surface of the lens 104 on which the second phase plate 113 and the PBS 114 are laminated has a planar shape. This configuration can secure a sufficient eye relief and reduce the thickness of the display optical system. In a case where this surface is concave on the observation side, the thickness of the lens increases in order to secure the eye relief in the peripheral portion. Moreover, in a case where it is convex on the observation side, the thickness of the lens increases in order to secure the thickness of the edge of the lens. Therefore, in this embodiment, the lens 104 is a plano-convex lens.

In this embodiment, both the first phase plate 111 and the second phase plate 113 are quarter waveplates, but the phase difference may be shifted from λ/4 so as to cancel the birefringences of the lenses 104 and 105. In this case, the sum of the phase differences of the lens 104 and the second phase plate 113 may be 3λ/20 or more and 7λ/20 or less. The sum of the phase differences of the lens 105 and the first phase plate 111 may be 3λ/20 or more and 7λ/20 or less. In a case where it becomes outside this range, the intensity of the ghost light increases and natural image observation becomes impossible.

This embodiment uses an organic EL element that emits unpolarized light as the display element, but may use a liquid crystal display that emits linearly polarized light as the display element to eliminate the first polarizing plate 110 and reduce the thickness of the display optical system.

### Second Embodiment

FIG. 6 illustrates the configuration of an HMD 201 as an image display apparatus using a display optical system according to a second embodiment, viewed from above. Reference numeral 202 denotes the right eye of the observer, and reference numeral 203 denotes the left eye of the observer. Lenses 204 and 205 are cemented together and form a part of the right-eye display optical system, and lenses 206 and 207 are cemented together and form a part of the left-eye display optical system. Reference numeral 208 denotes a right-eye display element, and reference numeral 209 denotes a left-eye display element, and each of them is also made of an organic EL element in this embodiment.

The right-eye display optical system enlarges light (virtual image) from an original image displayed on the right-eye display element 208 and guides it to the right eye 202 disposed on the observation side, and the left-eye display optical system enlarges light from an original image displayed on the left-eye display element 209 and guides it to the left eye 203 disposed on the observation side.

Each of the right-eye display optical system and the left-eye display optical system has a focal length f2 of 13 mm, a horizontal display angle of view of 60°, a vertical display angle of view of 60°, and a diagonal display angle of view 2×θ2 of 78°. In order to enhance the immersion of the observer who observes an image, the diagonal display angle of view may be 75° or more. An eye relief E2 is 18 mm.

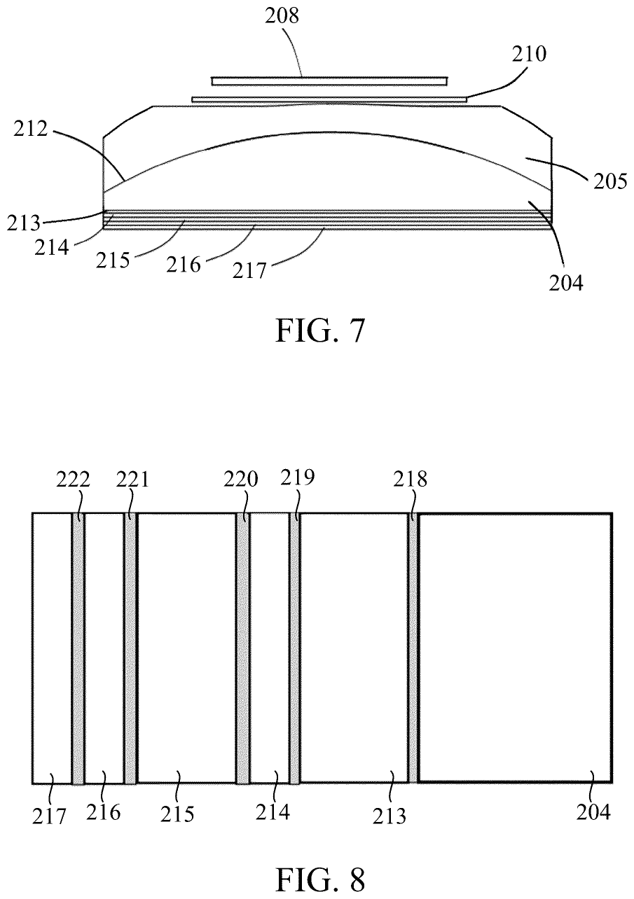

The display optical system according to this embodiment is also an optical system that folds the optical path by utilizing polarization, and its specific configuration will be described using the right-eye display optical system illustrated in FIG. 7. The right-eye display optical system includes, in order from the display element side, a first polarizing plate 210 disposed between the right-eye display element 208 and the lens 205, a PBS 212 disposed between the lens 204 and the lens 205, a first phase plate 213, a half-mirror 214, a second phase plate 215, a second polarizing plate 216, and an AR film 217 disposed between the lens 204 and the right eye 202.

Each of the first phase plate 213, the half-mirror 214, the second phase plate 215, and the second polarizing plate 216 has a planar shape and they are laminated. Each of the first phase plate 213 and the second phase plate 215 includes a quarter waveplate.

A polarization direction of polarized light that transmits through the first polarizing plate 210 and a polarization direction of polarized light that transmits through the PBS 212 coincide with each other, and the slow axis of the first phase plate 213 is tilted by 45° with respect to these polarization directions. The polarization direction of the polarized light that transmits through the first polarizing plate 210 and the slow axis of the second phase plate 215 are tilted by −45°. The polarization direction of the polarized light that transmits through the PBS 212 and the polarization direction of the polarized light that transmits through the second polarizing plate 216 coincide with each other.

In the above configuration, the unpolarized light emitted from the right-eye display element 208 transmits through the first polarizing plate 210 and becomes linearly polarized light. This linearly polarized light transmits through the PBS 212 and then through the first phase plate 213 and becomes circularly polarized light. The circularly polarized light reflected by the half-mirror 214 transmits through the first phase plate 213 and becomes linearly polarized light. Since the polarization direction of this linearly polarized light is perpendicular to the polarization direction of the polarized light that transmits through the PBS 212, it is reflected by the PBS 212 and then transmits through the first phase plate 213 and becomes circularly polarized light. The circularly polarized light that transmits through the half-mirror 214 transmits through the second phase plate 215 and becomes linearly polarized light. Since the polarization direction of this linearly polarized light coincides with the polarization direction of the polarized light that transmits through the second polarizing plate 216, it transmits through the second polarizing plate 216 and then through the AR film 217 and is guided to the right eye 202.

In this embodiment, the second polarizing plate 216 is disposed to absorb the light that is emitted from the right-eye display element 208 and first transmits through the half-mirror 214. The above configuration is similarly applied to the left-eye display optical system.

Folding the optical path utilizing polarization as in this embodiment can reduce the thickness of the display optical system and the focal length, and achieve image observation at a wide angle of view.

In this embodiment, each of the lenses 204, 205, 206, and 207 is made of resin to reduce the weight of the display optical system, and aspheric lenses can enhance the aberration correcting effect. The exit pupil position of the display optical system in this embodiment is 28 mm, which is the eye relief of 18 mm plus the eyeball rotation radius of 10 mm, and the exit pupil diameter is 6 mm.

FIG. 8 illustrates the first phase plate 213, half-mirror 214, second phase plate 215, and second polarizing plate 216, which are laminated on the observation-side surface of lens 104 and adhered together by an adhesive. An adhesive layer 218 is provided between the observation-side surface of the lens 204 and the first phase plate 213, an adhesive layer (first adhesive layer) 219 is provided between the first phase plate 213 and the half-mirror 214, and an adhesive layer 220 is provided between the half-mirror 214 and the second phase plate 215. An adhesive layer 221 is provided between the second phase plate 215 and the second polarizing plate 216.

Laminating the first phase plate 213, the half-mirror 214, the second phase plate 215, and the second polarizing plate 216 in this manner can reduce the thickness of the display optical system. An antireflection (AR) film 217 for preventing reflection of external light is adhered to the observation-side surface of the second polarizing plate 216 via an adhesive layer 222.

In this embodiment, the half-mirror 214 includes a film element. If the adhesive layer 219 between the half-mirror 214 and the first phase plate 213 adjacent to and disposed on the reflection side of the half-mirror 214 has a thickness variation (unevenness or irregularities) in the in-plane direction, unevenness corresponding to that unevenness will appear on the half-mirror 214. If the half-mirror 214 has unevenness, local optical power is generated in the half-mirror 214 for the light reflected by the half-mirror 214, a local focus shift occurs in the displayed image, and the displayed image is observed as a blurred image with decreased contrast.

Accordingly, this embodiment reduces the thickness of the adhesive layer 219 between the half-mirror 214 and the first phase plate 213, and suppresses the unevenness of the adhesive layer 219 and thereby the generation of local optical power in the half-mirror 214. More specifically, similarly to the first embodiment, the thickness of the adhesive layer 219 is set to 10 μm, and the variation amount in the thickness is suppressed to 5 μm (±2.5 μm). Basically, the thickness (d1) of the adhesive layer 219 between the half-mirror 214 having a reflecting action and the first phase plate 213 may be 5 μm or more and less than 20 μm. Similarly to the first embodiment, the thickness variation (Δd1) of the adhesive layer 219 may be less than 10 μm.

Similarly to the first embodiment, the thickness variation of the adhesive layer 219 within the width of the light beam incident on the observer's eye near the optical axis of the display optical system, which corresponds to the vicinity of the center of the display image, may be as small as possible. More specifically, in a case where the light beam emitted from a pixel on the optical axis of the display optical system among the display elements is reflected by the half-mirror 214, the ratio (Δd1/Φ1) of the thickness variation amount (Δd1) to the light beam width (Φ1) may be less than 0.002. In this embodiment, the thickness variation of the adhesive layer 219 near the center is 3 μm, and the diameter of the pupil of the observer's eye is about 4 mm, so the above ratio is 0.00075. The thickness of the half-mirror 214, 40 μm, is four times as long as the thickness of the adhesive layer 219. The thickness of the half-mirror 214 may be 3 times or more and 15 times or less as long as the thickness of the adhesive layer 219.

The thickness of the adhesive layer 220 between the half-mirror 214 and the second phase plate 215 may be reduced to suppress the thickness variation. In this embodiment, the thickness of the adhesive layer 220 is 10 μm, and the thickness variation is 5 μm (±2.5 μm). The thickness variation of the adhesive layer 220 near the center is 3 μm, and the ratio to the light beam width near the center is 0.00075.

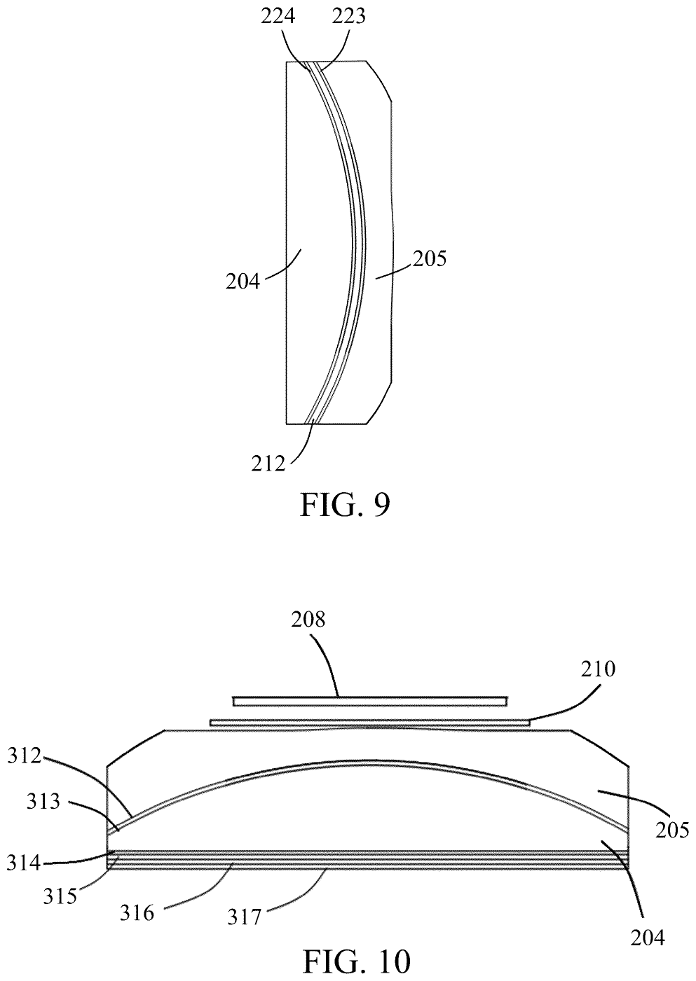

In this embodiment, as illustrated in FIG. 9, an adhesive layer 223 is provided between the lens 205 and the PBS 212 to adhere them together, and an adhesive layer 224 is provided between the PBS 212 and the lens 204 to adhere them together. By adhering the PBS 212 having a curved surface to the lenses 204 and 205 in this manner, the design freedom of the display optical system is improved, and a thinner structure and a wider angle of view can be achieved.

In this embodiment, the PBS 212 also includes a film element. Therefore, if the adhesive layer 224 between the PBS 212 and the lens 204 adjacent to and disposed on the reflection side of the PBS 212 has unevenness, unevenness corresponding to that unevenness will appear on the PBS 212, and the PBS 212 will generate local optical power for the light reflected by the PBS 212. As a result, a local focus shift occurs in the displayed image, and the displayed image is observed as a blurred image with decreased contrast.

Accordingly, this embodiment also reduces the thickness of the adhesive layer (first adhesive layer) 224, and suppresses the thickness variation and the unevenness of the adhesive layer 224. This embodiment similarly reduces the thickness of the adhesive layer 223 between the PBS 212 and the lens 205. More specifically, the thickness (d1) of each of the adhesive layers 223 and 224 is 15 μm, and the thickness variation amount (Δd1) is 8 μm (±4 μm). Basically, the thickness of the adhesive layer 224 between the PBS 212 having a reflecting action and the lens 204 may be 5 μm or more and less than 20 μm. The thickness variation of the adhesive layer 224 may be less than 10 μm.

The thickness variation of each of the adhesive layers 223 and 224 near the center is 3 μm, and since the size of the pupil of the observer's eye is about 4 mm, the ratio to the light beam width (Δd1/Φ1) near the center is 0.00075. This ratio may be less than 0.002. The thickness of the PBS 212 is 80 μm, which is 5.3 times as long as the thickness of each of the adhesive layers 223 and 224. The thickness of the PBS 212 may be 3 times or more and 15 times or less as long as the thickness of the adhesive layers 223 and 224.

Thus, this embodiment reduces the thickness of the adhesive layer between the half-mirror 214 or PBS 212 and the polarization element (first phase plate 213) or lens 204 adjacent to and disposed on the reflection side of the half-mirror 214 or PBS 212 to suppress the thickness variation. This configuration can reduce unevenness on the half-mirror 214 or PBS 212. Since the half-mirror 214 or PBS 212 has a reflecting action, its local unevenness more significantly affects the optical power than a surface with a transmitting action, and is more likely to cause a local contrast decrease in the displayed image. Therefore, reducing the unevenness of the adhesive layer between the half-mirror 214 or PBS 212 and the first phase plate 213 or lens 204 adjacent to and disposed on the reflection side of the half-mirror 214 or PBS 212 can reduce the unevenness of the half-mirror 214 or PBS 212 and suppress the local contrast decrease in the displayed image.

In this embodiment, the AR film 217 is adhered to the second polarizing plate 216 via the adhesive layer (second adhesive layer) 222. Similarly to the half-mirror 214 and the PBS 212, in a case where there is unevenness at the interface between the AR film 217 and air, local optical power is generated in the AR film 217, and the contrast of the displayed image decreases. Accordingly, this embodiment reduces the thickness of the adhesive layer 222 between the AR film 217 and the second polarizing plate 216 to suppress the thickness variation and the unevenness of the AR film 217.

In this embodiment, the thickness of the adhesive layer 222 is 10 μm, and the thickness variation is 10 μm (±5 μm). Basically, the thickness (d2) of the adhesive layer 222 between the AR film 217, which has a transmitting effect, and the second polarizing plate 216 may be 5 μm or more and less than 20 μm, and the thickness variation (Δd2) may be less than 20 μm. The thickness variation of the adhesive layer 222 near the center (Δd2) is 10 μm, and the ratio (Δd2/Φ2) to the light beam width (Φ2) near the center is 0.0025. This ratio may be less than 0.005.

Each pair of the lenses 204 and 205 and the lenses 206 and 207 in this embodiment is a cemented lens. The cemented lens can be easily held in the HMD 201 in comparison with using two separate lenses. Thus, the lens surface on which the half-mirror 214 is vapor-deposited may be the observation-side surface of the lens 205. Even in this case, the surface on which the half-mirror 214 is vapor-deposited has a convex shape toward the display element side. Vapor-depositing the half-mirror 214 on the convex surface can achieve a wide angle of view and reduce the thickness of the display optical system. Furthermore, making the convex surface on which the half-mirror 214 is vapor-deposited an aspheric shape can enhance the aberration correcting effect.

The observation-side surface of the lens 204 on which the first phase plate 213, the PBS 212, etc. are laminated has a planar shape. Thereby, the thickness of the display optical system can be reduced and sufficient eye relief can be secured. The lens 204 is a plano-convex lens.

In this embodiment, each of the first and second phase plates 213 and 215 is a quarter waveplate, but the phase difference may be shifted from λ/4 so as to cancel the birefringences of the lenses 204 and 205. In this case, the sum of the phase differences of the lens 204 and the second phase plate 215 may be 3λ/20 or more and 7λ/20 or less. The sum of the phase differences of the lens 205 and the first phase plate 213 may be 3λ/20 or more and 7λ/20 or less. In a case where it becomes outside this range, the intensity of ghost light increases and natural image observation becomes impossible.

This embodiment uses an organic EL element that emits unpolarized light as the display element, but may use a liquid crystal display that emits linearly polarized light as the display element to eliminate the first polarizing plate 210 and reduce the thickness of the display optical system.

### Third Embodiment

FIG. 10 illustrates a display optical system according to a third embodiment. This embodiment is a variation of the second embodiment, and those elements in this embodiment, which are corresponding elements in the second embodiment, will be designated by the same reference numerals.

In this embodiment, a PBS 312 and a first phase plate 313 are disposed between the lenses 204 and 205, and a half-mirror 314, a second phase plate 315, a second polarizing plate 316, and an AR coating 317 are laminated on the observation-side surface of the lens 204. The half-mirror 314 is evaporated on the display-element-side surface of the lens 204, and the AR coating 317 is evaporated on the observation-side surface of the second polarizing plate 316.

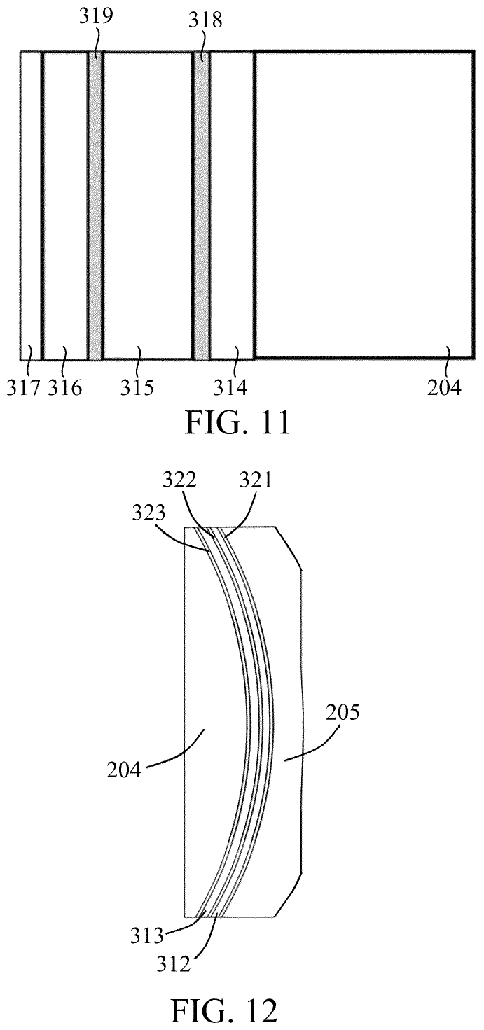

In this configuration, as illustrated in FIG. 11, an adhesive layer 319 is provided between the second phase plate 315 and the second polarizing plate 316 to adhere them together. An adhesive layer 318 is provided between the second phase plate 315 and the half-mirror 314 evaporated on the lens 204 to adhere them together.

As illustrated in FIG. 12, an adhesive layer 322 is provided between the PBS 312 and the first phase plate 313 to adhere them together. An adhesive layer 321 is provided between the PBS 312 and the lens 205, and an adhesive layer 323 is provided between the first phase plate 313 and the lens 204.

The PBS 312 includes a film element, and if the adhesive layer 322 between the PBS 312 and the polarization element (first phase plate 313) adjacent to and disposed on the reflection side of the PBS 312 has unevenness, unevenness corresponding to that unevenness will appear on the PBS 312. As a result, local optical power is generated in the PBS 312 for the light reflected by the PBS 312. As a result, a local focus shift occurs in the displayed image, and the displayed image is observed as a blurred image with decreased contrast.

Accordingly, this embodiment reduces the thickness of the adhesive layer (first adhesive layer) 322 between the PBS 312 and the first phase plate 313 to suppress the thickness variation and thereby the unevenness on the PBS 312. In this embodiment, the thickness (d1) of the adhesive layer 322 is 10 μm, and the thickness variation (Δd1) is 8 μm (±4 μm). Basically, the thickness of the adhesive layer 322 may be 5 μm or more and less than 20 μm, and the thickness variation may be less than 10 μm.

The thickness variation of the adhesive layer 322 near the center is 4 μm, and since the size of the pupil of the observer's eye is about 4 mm, a ratio (Δd1/Φ1) to the light beam width (Φ1) near the center is 0.001. This ratio may be less than 0.002. The thickness of the PBS 312 is 45 μm, which is 4.5 times as long as the thickness of the adhesive layer 322. The thickness of PBS 312 may be 3 times or more and 15 times or less as long as the thickness of the adhesive layer 322.

The thickness of the adhesive layer 321 between the PBS 312 and lens 205 as well may be reduced to suppress the thickness variation. In this embodiment, the thickness of the adhesive layer 321 is 15 μm, and the thickness variation is 6 μm (±3 μm). The thickness variation of the adhesive layer 321 near the center is 4 μm, and the ratio to the light beam width near the center is 0.001.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide a display optical system in which even if an adhesive layer for attaching a film element is provided, a local contrast decrease of a displayed image is small.

This application claims priority to Japanese Patent Application No. 2024-019879, which was filed on Feb. 14, 2024, and which is hereby incorporated by reference herein in its entirety.

What is claimed is:

1. A display optical system configured to guide light from a display element to an observation side, the display optical system comprising:
a half-transmissive reflective surface;
a polarization separation surface; and
a plurality of polarization elements,
wherein at least one of surfaces having refractive power in the display optical system is aspheric,
wherein at least one of the half-transmissive reflective surface or the polarization separation surface includes a film element,
wherein the film element is adhered to one of the plurality of polarization elements or a lens via a first adhesive layer on a reflection side of the film element, and
wherein the following inequality is satisfied:
$$5 μm \leq d 1 < 20 μm$$
where d1 is a thickness of the first adhesive layer.

2. The display optical system according to claim 1, wherein the following inequality is satisfied:
0<Δd1<10 μm
where Δd1 is a thickness variation amount in an in-plane direction of the first adhesive layer.

3. The display optical system according to claim 1, wherein in a case where a light beam emitted from a pixel on an optical axis of the display optical system among the plurality of display elements is reflected by the film element, the following inequality is satisfied:
$$0 < Δ d 1 / Φ 1 < 0.002$$
where Δd1 is a thickness variation amount in an in-plane direction of the first adhesive layer, and Φ1 is a light beam width of the light beam.

4. The display optical system according to claim 3, wherein in a case where the thickness variation amount changes periodically in the in-plane direction, a changing period of the thickness variation amount is twice or more as long as the light beam width Φ1.

5. The display optical system according to claim 1, wherein the thickness of the film element is three times or more and 15 times or less as long as the thickness of the first adhesive layer.

6. The display optical system according to claim 1, comprising, in order from a display element side:
a first polarizing plate;
a first phase plate;
the half-transmissive reflective surface;
a second phase plate;
the polarization separation surface; and
a second polarizing plate,
wherein the film element constituting the polarization separation surface is adhered to the second phase plate via the first adhesive layer.

7. The display optical system according to claim 1, comprising, in order from a display element side:
a first polarizing plate;
the polarization separation surface;
a first phase plate;
the half-transmissive reflective surface;
a second phase plate; and
a second polarizing plate,
wherein the film element constituting the half-transmissive reflective surface is adhered to the first phase plate via the first adhesive layer.

8. The display optical system according to claim 1, comprising, in order from a display element side:
a first polarizing plate;
the polarization separation surface;
the lens;
a first phase plate;
the half-transmissive reflective surface;
a second phase plate; and
a second polarizing plate,
wherein the film element constituting the polarization separation surface is adhered to the lens via the first adhesive layer.

9. The display optical system according to claim 1, further comprising a polarizing plate disposed closest to the observation side, and an antireflection film is adhered to the polarizing plate via a second adhesive layer, and
wherein the following inequality is satisfied:
$$5 μm \leq d 2 < 20 μm$$
where d2 is a thickness of the second adhesive layer.

10. The display optical system according to claim 8, wherein the following inequality is satisfied:
0<Δd2<20 μm
where Δd2 is a thickness variation amount of the second adhesive layer in an in-plane direction of the second adhesive layer.

11. The display optical system according to claim 10, wherein in a case where a light beam emitted from a pixel on an optical axis of the display optical system among the plurality of display elements transmits through the second adhesive layer, the following inequality is satisfied:
$$0 < Δ d 2 / Φ 2 < 0.005$$
where Φ2 is a light beam width of the light beam that transmits through the second adhesive layer.

12. The display optical system according to claim 1, wherein the following inequality is satisfied:
10 mm≤f≤20 mm
where f is a focal length of the display optical system.

13. An image display apparatus comprising:
a display optical system configured to guide light from a display element to an observation side; and
a display element,
wherein the display optical system includes:
a half-transmissive reflective surface;
a polarization separation surface; and
a plurality of polarization elements,
wherein at least one of surfaces having refractive power in the display optical system is aspheric,
wherein at least one of the half-transmissive reflective surface or the polarization separation surface includes a film element,
wherein the film element is adhered to one of the plurality of polarization elements or a lens via a first adhesive layer on a reflection side of the film element, and
wherein the following inequality is satisfied:
$$5 μm \leq d 1 < 20 μm$$
where d1 is a thickness of the first adhesive layer.
